(19) United States
(12) Patent Application Publication
(10) Pub. No.: US 2022/0042452 A1
(43) Pub. Date: Feb. 10, 2022

(54) HYBRID POWER GENERATION SYSTEMS AND METHODS

(71) Applicant: Hybrixcel, Inc., Toronto (CA)

(72) Inventor: Sara Shahmohammadi, Toronto (CA)

(73) Assignee: Hybrixcel, Inc., Toronto (CA)

(21) Appl. No.: 17/395,664

(22) Filed: Aug. 6, 2021

Related U.S. Application Data
(60) Provisional application No. 63/062,667, filed on Aug. 7, 2020.

(51) Int. Cl. F02C 1/05; F02C 7/18

(52) U.S. Cl. CPC F02C 1/05; F02C 7/18; F05D 2260/213; F05D 2220/76; F05D 2260/232; F05D 2220/32

(57) ABSTRACT

A thermodynamic power generation system for generating power from a low-grade or mid-grade heat source includes a turbine coupled to an electrical generator and a closed circuit fluid flow path for a refrigerant. The system also includes an adsorption thermal compressor positioned in the flow path, the adsorption thermal compressor comprising an inlet buffer vessel, an outlet buffer vessel, and two or more fluidized adsorber beds, each containing a sorbent. The fluidized adsorber beds are arranged in parallel. The system also includes a refrigerant configured to circulate within the fluid flow path, the turbine, and the adsorption thermal compressor, for driving the turbine. The refrigerant is configured to be adsorbed and desorbed by the sorbent in a vapor phase without condensing into a liquid phase. The two or more fluidized adsorber beds each cycle between an adsorption phase and a desorption phase.

### CROSS-REFERENCE TO RELATED APPLICATIONS

This application claims the benefit of U.S. Provisional Application No. 63/062,667 filed on Aug. 7, 2020, which is incorporated by reference herein in its entirety.

### TECHNICAL FIELD

This disclosure relates generally to systems and methods for generating power from low-grade and/or mid-grade heat sources, and more specifically to systems and methods that include a thermodynamic power generation system enhanced by the use of two or more fluidized adsorber beds. Embodiments disclosed herein combine the fields of thermodynamics and material sciences with power generation systems and methods.

### BACKGROUND

There is a significant amount of heat that may be characterized as low-grade and/or mid-grade (e.g. low temperature geothermal heat, hot liquid from a solar collector, warm ocean waters, and waste heat from industrial processes) generated in the world, which may be a drag on economic performance, and/or causing environmental damage. This heat cannot be effectively utilized using currently available technologies due to limitations of cost, size, complexity of integration with other energy sources, and the need for relatively high operating temperatures.

Heat extraction from low temperature heat sources is not considered technically difficult, but such heat extraction is typically regarded as uneconomical due to the low heat to power conversion efficiency of the current state-of-the-art heat recovery systems. For example, using the geothermal classification, heat sources of >200° C. are typically regarded as high, and conversion efficiency may reach 25% or greater. Heat sources in the 150° C.-200° C. range are typically classified as moderate, and conversion efficiencies generally range from 20-25% A heat source in the 100° C.-150° C. range is typically regarded as low, and heat to power conversion efficiencies are typically less than 10%.

Conversion efficiency in general is limited by the second law of thermodynamics:

$$H = \frac{{Q}_{i n} - {Q}_{rej}}{{Q}_{i n}} = \frac{Work}{{Q}_{i n}} \qquad ( 1 )$$

where Qᵢₙ is the heat input, and Qᵣₑⱼ is the heat rejection (e.g. in Rankine and organic Rankine cycles the latent heat of condensing the low pressure exhaust vapor back to liquid). With a conversion efficiency of only 10%, the latent heat in the exhaust represents 90% of the input heat, and therefore the condenser cooling would require e.g. large cooling towers which can be very expensive and, for wet cooling, waste a lot of water that is made to evaporate for the cooling effect. Low conversion efficiencies also decrease the power density of the converting machine, and may also increase required capital investment.

To improve energy efficiency in industry, low-grade to mid-grade heat recovery technologies have been developed. Generally, state-of-the-art technologies for low-grade heat recovery and utilization are based on the concept of thermodynamic cycles. Known technologies include adsorption, absorption, liquid desiccant, Rankine cycles, ORC, and Kalina cycles.

The concept of a thermally driven refrigeration cycle using a solid adsorbent (“adsorption cooling”) was developed from the work of Tchernev (1978) on the water-zeolite system. Such systems are now commercially available, and are typically used to generate chilled water from solar energy or waste heat. A typical adsorption cooling system consists of one or more packed beds of a suitable sorbent, a condenser, and an evaporator. The most common application uses water as the refrigerant and silica gel as the sorbent.

The concept of using a fluidized bed to enhance the performance of an adsorption chiller was published by Wang et al. (2012). They found that the heat and mass transfer rates were enhanced by fluidization compared to a traditional fixed bed, effectively shortening the cycle time, and allowing the same refrigeration power to be provided with less sorbent.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

An object of the present disclosure is to provide thermodynamic power generation systems that can efficiently use low to mid-grade heat for power generation. Another object of the present disclosure is to provide methods for the operation of such power generation systems.

In systems and methods disclosed herein, an innovative state-of-the-art power generation process, referred to herein as a HYBRX cycle, may be used to increase the cycle efficiency of a typical organic Rankine cycle (ORC). For example, systems based on a HYBRX cycle may eliminate the significant parasitic loss and cost of problematic components such as evaporators, condensers, and/or pressure pumps that are used in conventional ORC systems. The HYBRX cycle is based on the concept of thermodynamic cycles utilizing a hybrid of two different sub-cycles characteristics, namely an adsorption refrigeration cycle, and an optimized organic Rankine cycle (ORC) pumping low-grade to mid-grade heat (e.g. from renewable energy sources or from industrial processes) and converting the pumped, higher temperature heat to power a turbine.

In the HYBRX cycle, a standard ORC is enhanced by adding a multibed adsorption thermal compressor containing advanced sorbent materials such as nanostructured metal organic frameworks (MOFs) to provide a MOF fluidized adsorption thermal compressor. Systems and methods containing advanced sorbent materials with strong uptake capabilities for the selected organic working fluids may be suited to operate with a wide range of input heat sources, while generating more power (e.g. up to 125% more) than standard ORC systems.

Thermodynamic power generation systems based on a HYBRX cycle operate as a cyclic system, in which an improved working fluid vapor is adsorbed into the nanostructured pores of a MOF sorbent, resulting in near liquid phase density. This process may take the place of condensing the working fluid vapor back to a liquid state. When heat is subsequently applied to the MOF, the working fluid vapor is released from the MOF pores, and significant pressure may be generated. This process may take the place of evaporating the working fluid back to a vapor state. As a result, in such systems the working fluid may remain in a vapor state the entire time.

In accordance with one broad aspect of this disclosure, there is provided a thermodynamic power generation system for generating power from a low-grade or mid-grade heat source, the system comprising: a turbine coupled to an electrical generator; a closed circuit fluid flow path for a refrigerant, the fluid flow path extending from an outlet of the turbine to an inlet of the turbine, such that the turbine is within the flow path; an adsorption thermal compressor positioned in the flow path, the adsorption thermal compressor comprising: an inlet buffer vessel; an outlet buffer vessel; two or more fluidized adsorber beds, each adsorber bed containing a sorbent, the two or more fluidized adsorber beds being arranged in parallel, with an inlet end of each adsorber bed in fluid communication with the inlet buffer vessel, and with an outlet end of each adsorber bed in fluid communication with the outlet buffer vessel; a refrigerant configured to circulate within the fluid flow path, the turbine, and the adsorption thermal compressor, for driving the turbine, wherein the refrigerant is configured to be adsorbed and desorbed by the sorbent in a vapor phase without condensing into a liquid phase; wherein the two or more fluidized adsorber beds are in thermal communication with the low-grade or mid-grade heat source, wherein the two or more fluidized adsorber beds are configured to transfer heat from the low-grade or mid-grade heat source to the refrigerant; and wherein the two or more fluidized adsorber beds each cycle between an adsorption phase and a desorption phase.

In some embodiments, the two or more fluidized adsorber beds operate out of phase with one another, such that at least one fluidized adsorber bed is adsorbing refrigerant while at least one other fluidized adsorber bed is desorbing refrigerant.

In some embodiments, refrigerant exiting the outlet of the turbine is configured to flow into one of the fluidized adsorber beds during an adsorption phase, and wherein refrigerant entering the inlet of the turbine is configured to flow from one of the fluidized adsorber beds during a desorption phase.

In some embodiments, the two or more fluidized adsorber beds comprise four fluidized adsorber beds, and the four fluidized adsorber beds alternately cycle between a precooling phase, an adsorption phase, a pre-heating phase, and a desorption phase.

In some embodiments, the closed circuit fluid flow path lacks a condenser.

In some embodiments, the closed circuit fluid flow path lacks an evaporator.

In some embodiments, the closed circuit fluid flow path lacks a refrigerant pump.

In some embodiments, the sorbent comprises a metal organic framework with a chemical affinity for the refrigerant.

In some embodiments, the sorbent comprises at least one metal selected from groups Ia, IIa, IIIa, Iva to VIIIa, and Ib to VIb, wherein the at least one metal has a chemical affinity for the refrigerant.

In some embodiments, the sorbent comprises at least one metal selected from the group consisting of Mg, Ca, Sr, Ba, Sc, Y, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, Hg, Al, Ga, In, Ti, Si, Ge, Sn, Pb, As, Sb, Bi, and the lanthanide family, wherein the at least one metal has a chemical affinity for the refrigerant.

In some embodiments, the sorbent comprises at least one metal selected from the group consisting of Zr, Cr, and Fe, wherein the at least one metal has a chemical affinity for the refrigerant.

In some embodiments, the sorbent comprises a covalent organic framework with a chemical affinity for the refrigerant.

In some embodiments, the sorbent comprises a hierarchical porous carbon with a chemical affinity for the refrigerant.

In some embodiments, the sorbent comprises a zeolite or mesoporous silica framework with a chemical affinity for the refrigerant.

In some embodiments, the sorbent comprises a composite combination of two or more of a metal organic framework, a covalent organic framework, a hierarchical porous carbon, and a zeolite or mesoporous silica framework, and wherein the sorbent is in the form of a mixed matrix with a chemical affinity for the refrigerant.

In some embodiments, the fluidized adsorber beds are configured to provide a high capacity uptake of the refrigerant in pores of the sorbent while the refrigerant remains in vapor phase.

In some embodiments, the adsorption thermal compressor further comprises a periodic adsorption power generation system.

In some embodiments, when a fluidized adsorber bed is in the desorption phase, an output pressure of the adsorber bed falls to a minimum while a temperature of the adsorber bed rises to a maximum, and wherein, when a fluidized adsorber bed is in the adsorption phase, the output pressure of the adsorber bed increases to a maximum while the temperature of the adsorber bed falls to a minimum.

In some embodiments, the refrigerant comprises a pure hydrofluorocarbon (HFC) or hydrofluoroolefin (HFO).

In some embodiments, the refrigerant comprises a mixture of two or more hydrofluorocarbons (HFCs) or hydrofluoroolefins (HFOs).

It will be appreciated by a person skilled in the art that a method or apparatus disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a schematic diagram of a conventional ORC power generation system;

FIG. 2 is a schematic diagram of a two-bed hybrid adsorption-desorption system;

FIG. 3 is a schematic block diagram of an adsorption bed heat recovery system process, in accordance with one embodiment;

FIG. 4 is a schematic flow sheet diagram of a multi-bed bubbling fluidized adsorption power system;

FIG. 5 is a data plot for R134a loading on MIL-101(Cr);

FIG. 6 is a data plot for a Langmuir model, extended to 20 bar (a), showing one possible combination of adsorbing/desorbing conditions;

FIG. 7 is a data plot for fluidization regimes depending on particle size and density difference; and

FIG. 8 is a data plot for a typical heat transfer coefficient in a fluidized bed as a function of velocity.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The overarching purpose of systems and methods disclosed herein is to convert low-grade or mid-grade heat into electricity. The disclosed technology exploits the known property of certain sorbents, nominally a metal-organic framework (MOF), to adsorb and desorb fluorocarbon refrigerants depending on temperature. More specifically, the disclosed technology extends this concept by integrating a MOF fluidized adsorption thermal compressor to improve heat and mass transfer.

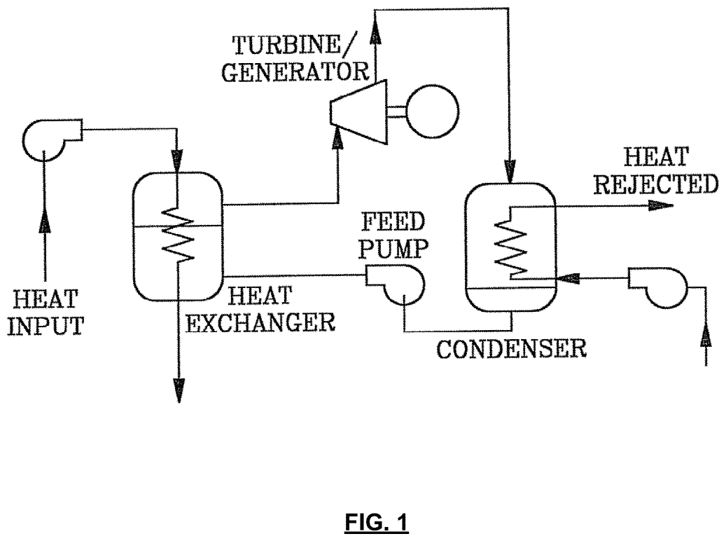

FIG. 1 illustrates a basic schematic of a conventional ORC system. Among many conventional power cycles, one widely promising cycle used in exploitation of low-grade and mid-grade heat sources (e.g. geothermal resources and waste heat recovery of industrial processes) is the Rankine cycle. In a Rankine cycle, a working fluid is: (i) pressurized as a liquid; (ii) vaporized by receiving the waste heat; (iii) expanded to recover mechanical work; and, (iv) condensed and cooled to complete the cycle.

The organic chemicals typically used by an ORC include traditional refrigerants, such as iso-pentane, chlorofluorocarbons (CFCs), hydrofluorocarbons (HFCs), butane, propane, and ammonia. Such traditional refrigerants typically require high temperature heat sources between 100° C. (212° F.) and 143° C. (290° F.), and cannot operate effectively at temperatures higher than 143° C. or less than 37° C. (100° F.). A refrigerant capable of operating outside these temperature ranges may therefore be considered desirable.

In systems and methods disclosed herein, refrigerants may include a mixture of two or more of the following components: HFC 134a (1,1,1,2-tetrafluoro ethane, having a chemical formula of CHF); HFC245fa (1,1,1,3,3-pentafluoropropane, having a chemical formula of CHFs); HFC365mfc (1,1,1,3,3-pentafluorobutane, having a chemical formula of CHFs); etc. Such refrigerant mixtures may differ from the traditional pure refrigerants in that they may boil at extremely low temperatures and are capable of capturing heat at temperatures less than 23° C. (73° F.), thus facilitating power generation power from low and medium heat sources (e.g. industrial waste heat). Alternatively, a single ‘pure’ refrigerant may be used.

The composition of refrigerant mixtures may be adjusted so that the mixture may boil and generate power over a wide range of heat source temperatures from as low as 23° C. to 480° C. (about 70 to 900° F.). The refrigerant mixtures may be characterized by variable saturation temperatures, and their boiling points may be tailored to maximize the heat absorption at the evaporator and produce improved, and preferably optimized, power generation.

As a result, such refrigerant mixtures may produce power from captured low and medium heat sources in applications such as process industries, solar and geothermal energy, gray water and warm ocean waters. Compared with using typical fossil fuels, using an organic Rankine cycle with refrigerant mixtures as disclosed herein may significantly reduce the output of NOₓ compounds (i.e., NO₂ and NO₃) and CO. Further, the present quaternary refrigerant mixtures may have a long life-cycle therefore require reduced maintenance and repair costs. These factors may result in a relatively short payback period for an initial investment, when compared to existing ORC systems.

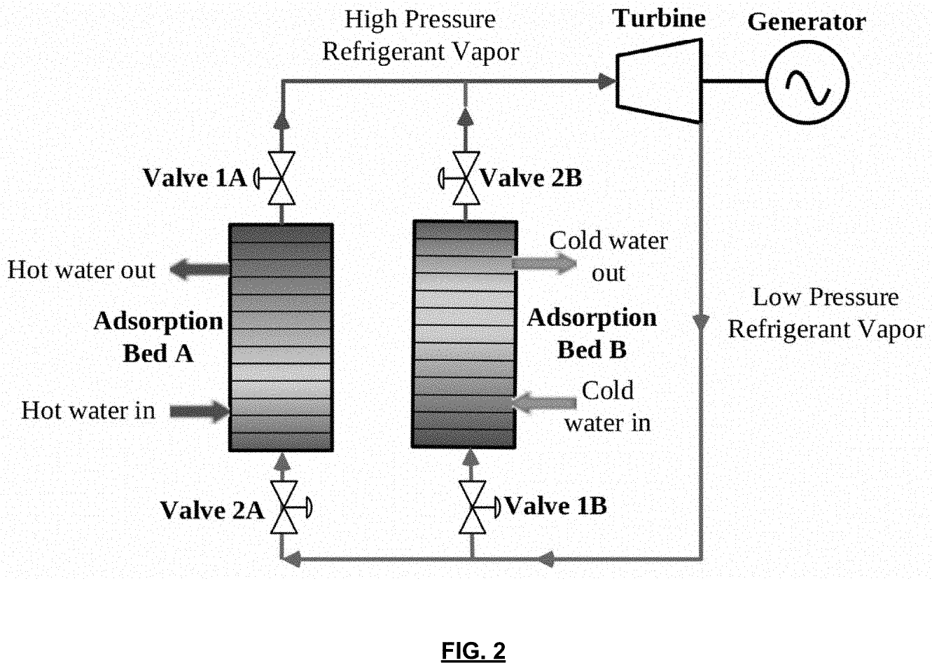

FIG. 2 illustrates a basic schematic of an exemplary MOF fluidized compression system that includes two adsorption beds for the adsorption and desorption processes during the cycle. Four valves are necessary for the operation of this cycle.

When heat is available, the adsorption bed A, which begins saturated with refrigerant, is initially isolated from the turbine by valves 1A and 2A. In this process, when heat is applied to the adsorption bed A, its temperature and pressure increase. During the desorption process, valve 1A is opened while valve 2A remains closed. When the pressure of the full system rises up to the turbine pressure, the refrigerant evaporates and flows towards the turbine (expander). The desorbed vapor then enters the turbine—which is connected to an electric generator—and expands. The amount of desorbed refrigerant from the adsorption bed increases with increasing bed temperature and the adsorbate (refrigerant) concentration continues to decrease.

When the adsorption bed has reached the desirable refrigerant concentration, valve 1A between the turbine input and adsorption bed A is closed and the adsorption bed A is cooled to its initial temperature. The system pressure is reduced after the expansion. During the adsorption process, the adsorption bed B is at the initial temperature that connects to the turbine output through the valve 1B. This time valve 2B is closed. The low-pressure refrigerant vapor from the turbine output is adsorbed through the valve 1B by the cooled adsorption bed B. This completes the adsorption cycle. For continuous operation, the two adsorption beds work alternatively as an adsorption and desorption process.

When the absorption bed B is saturated with refrigerant vapor coming from the turbine, the valve 1B is closed and the valve 2B is opened. At this time the heat is applied to the adsorption bed B and starts for the desorption process. The cycle begins and the valve 2A is opened for the adsorption process by the adsorption bed A.

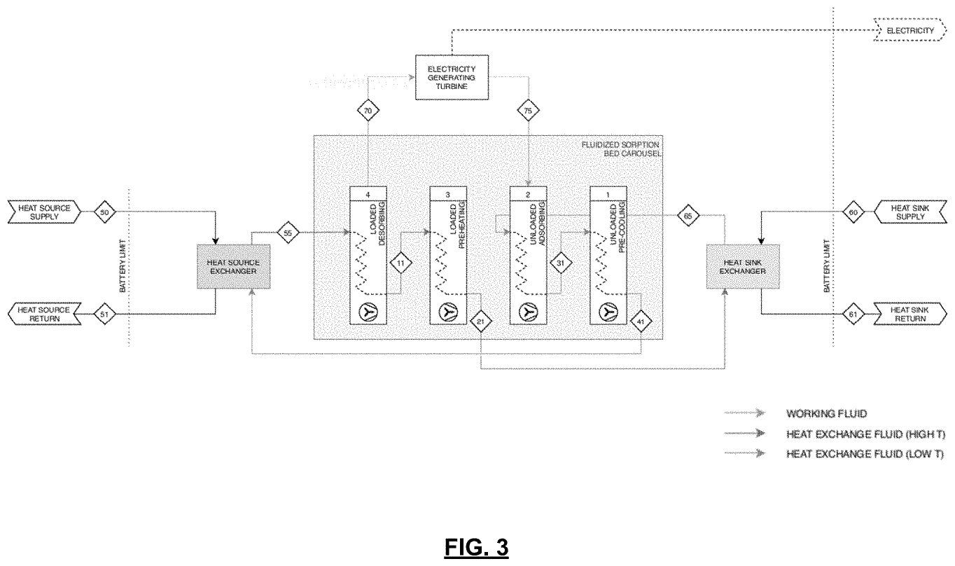

FIG. 3 illustrates a basic schematic model (preliminary process concept blocks) of an exemplary fluidized adsorption power generation (HYBRX) system according to the present disclosure. In the illustrated schematic, the system includes a carousel of four fluidized adsorption and desorption beds. It will be appreciated that more or fewer beds may be provided in alternative embodiments.

With reference to the system illustrated in FIG. 3, each bed may be rotated through the following sequence of four operations, or steps:
1. Unloaded and pre-cooling—The fluidized adsorption bed is in an unloaded state (e.g. discharged of its refrigerant). The bed may be taken to a lower pressure and/or pre-cooled. This operation mainly serves to lower the temperature of the solids in the bed and associated equipment (sensible heat) in anticipation of step 2;
2. Unloaded and adsorbing—The sorption bed adsorbs working fluid from the discharge of the turbine. It operates in a lower-pressure state. The sorption bed effectively performs the same function as a condenser in a traditional refrigerant cycle, but instead of transitioning from gas to liquid, the refrigerant transitions from gas to an adsorbed state. The adsorption is exothermic, so this step continues to reject heat to the heat sink until the bed reaches a predetermined loading level, or until a predetermined length of time has elapsed;
3. Loaded and preheating—The loaded sorbent bed may be pre-heated and allowed to start building pressure. This step mainly serves to raise the temperature of the solids in the bed and associated equipment (sensible heat), but may also begin to build up pressure in anticipation of step 4.
4. Loaded and discharging—The sorption bed acts to generate pressure and flow to feed the turbine. Unlike a traditional compressor, where mechanical energy is used to build pressure, the input of heat causes refrigerant to desorb from a sorbent, which releases gas and maintains pressure in the process. The pressurized gas may be released through an automatically sequenced valve to perform mechanical work in a downstream turbine. This step continues to accept heat from the heat source until the bed declines to a predetermined loading level.

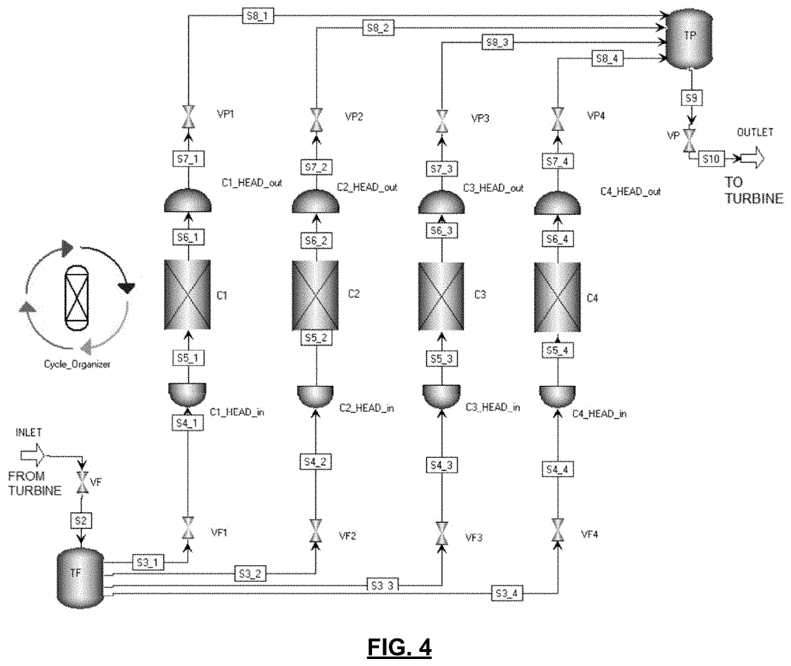

The flow sheet model illustrated in FIG. 4 was constructed in Aspen Adsorption V11. The model includes the following blocks:
Four fluidized adsorption beds, arranged in parallel, that each include a packed column Cn (C1, C2, C3, and C4) with internal heat exchangers, two empty heads Cn_HEAD_in and Cn_HEAD_out, an inlet valve VFn, and a discharge valve VPn;
An inlet buffer vessel TF;
An outlet buffer vessel TP;
A system inlet valve VF (always open);
A system discharge valve VP (always open);
Pipes S2, S3_n, S4_n, S5_n, S6_n, S7_n, S8_n, S9, S10; and
A “Cycle organizer” that sets the valve positions and heat exchange fluid temperature according to a pre-programmed sequence.

The system of FIG. 4 was modelled as an adiabatic system (no heat transfer into or out of the system). The thermal capacities of the sorbent and refrigerant were considered. The thermal capacity of the equipment and piping was not considered, since the equipment configuration may vary based on the particular implementation details. These assumptions are believed to be reasonable for a large, well-insulated system where the heats of chemical reactions and heating/cooling the sorbent dominate over the energy required to heat and cool the equipment itself. The thermal capacity of the equipment can be considered in future modeling, e.g. to refine the understanding of heat flow in a particular system.

The amount of refrigerant that loads onto a solid adsorbent depends on temperature and pressure. In HYBRX system, loading can be expected to increase at lower temperatures and higher pressures, and to decrease at higher temperatures and lower pressures. To date, calculations for HYBRX systems have been based on published data. It is expected that loading data collected experimentally (e.g. in a laboratory) will verify these calculations.

Loading isotherms (a mathematical model) were used in order to construct a simulation of the HYBRX process. Loading data for a R134A/MIL-101(Cr) system were published by Zheng et al. (2019) over the range of 15 to 35° C. and 0 to 5 bar (a). This loading data was fitted using a Langmuir temperature dependent isotherm model:

$${w}_{i} = \frac{{IP}_{1} {e}^{{IP}_{2} / {T}_{s}} {P}_{i}}{1 + {IP}_{3} {e}^{{IP}_{4} / {T}_{s}} {P}_{i}} \qquad ( 2 )$$

where wᵢ is loading in kmol/kg, Pᵢ is the partial pressure of the refrigerant in bar (a), T is temperature in K, and IPₓ are independent fitting parameters.

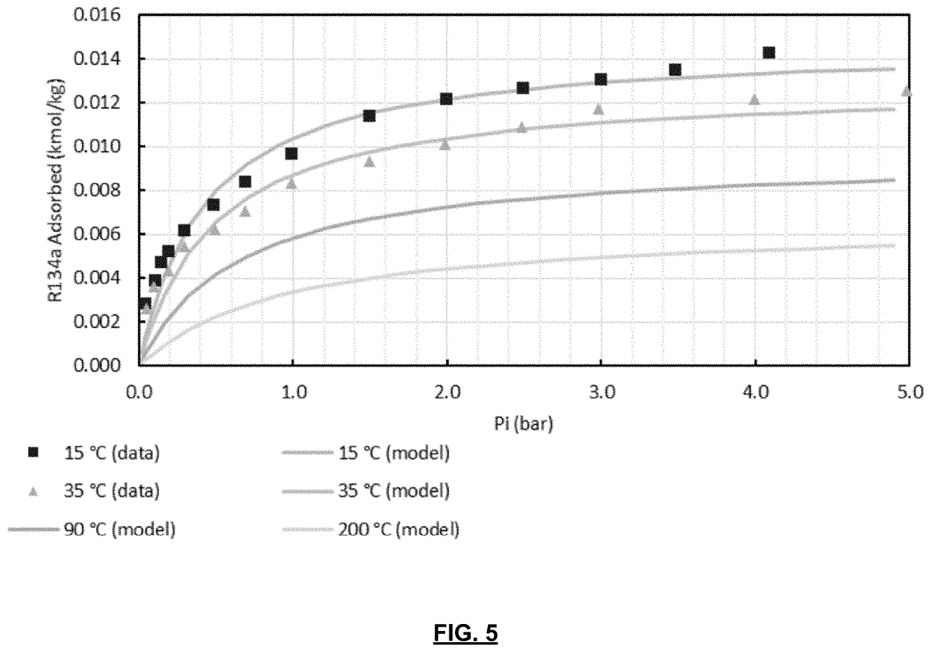

FIG. 5 shows the ‘raw’ loading data for 15° C. and 35° C., along with curves from the fitted model for 15° C., 35° C., 90° C., and 200° C. The isotherms were extended to higher temperature (90° C. and 200° C.) using the Clausius-Clapeyron relationship, which predicts the known thermodynamic data to different temperatures based on the measured heat of adsorption.

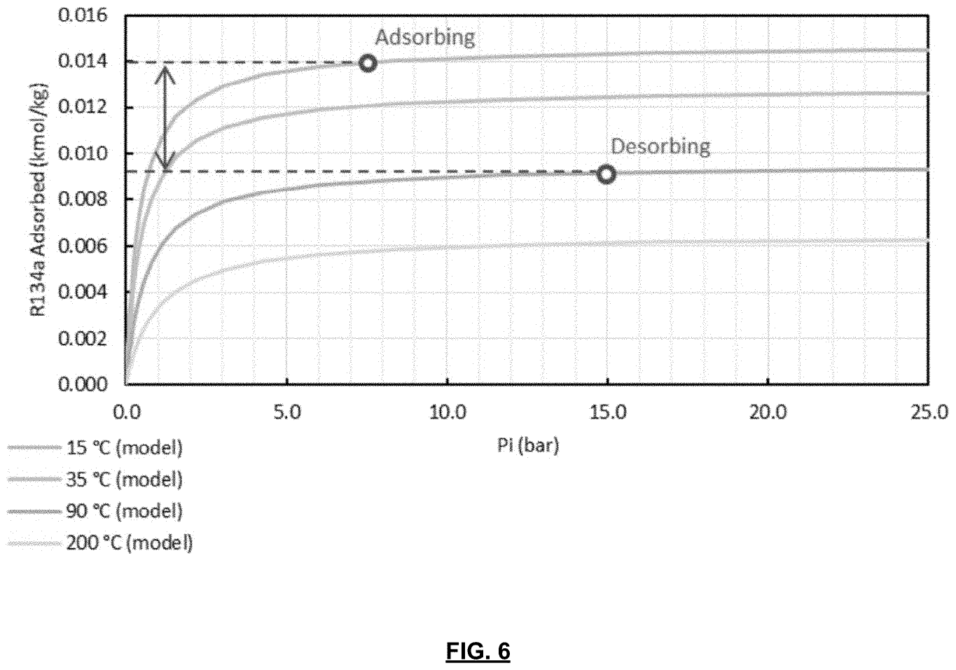

FIG. 6 illustrates curves from the fitted model for 15° C., 35° C., 90° C., and 200° C., extended to 30 bar (a), where HYBRX systems may operate. The dashed lines illustrate the maximum (equilibrium) swing in adsorption across a simulated cycle.

As discussed above, HYBRX systems and methods integrate a fluidized adsorption bed to improve heat and mass transfer. The fluidization behavior of spherical particles is strongly dependent on particle diameter and density. Larger, denser particles have higher terminal velocities, and also higher minimum fluidization velocities. This means they require more energy to fluidize. However, very small and low density particles exhibit other challenging fluidization behavior—the electrostatic forces between the particles becomes dominant over drag, which leads to channeling and poor fluidization as the particles adhere to one another.

These challenges can be overcome by use of special methods, such as high velocity gas jets, pulsating flow, and mechanical vibration of the beds. However, this usually leads to fluidization of more uniform agglomerates rather than true fluidization of nano-scale particles.

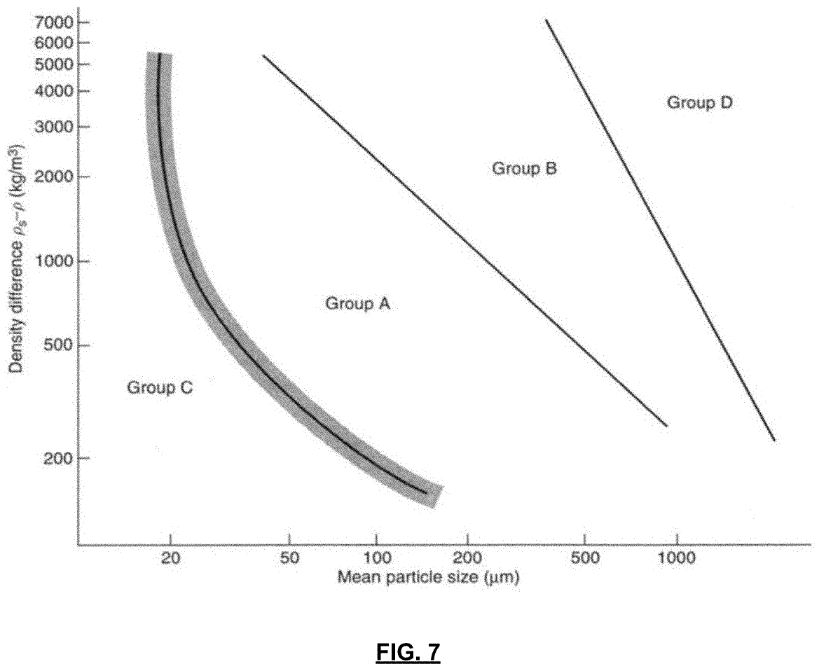

For conventional fluidization techniques, Geldart researched different powders and proposed a fluidization chart, an example of which is illustrated in FIG. 7. For HYBRX systems, it is expected that it will be desirable to use a material that can be processed into a “Group A” solid, as shown in FIG. 7. This is expected to allow stable fluidization over a good range of velocities/conditions as the conditions in the bed change through the charge/discharge cycle. Other important characteristics of the solid are a tight particle size distribution, and a high resistance to attrition. If there is a wide range of particle sizes, the system may suffer problems with entrainment of the finer particles into the turbine. If the particles are friable (susceptible to attrition through the mechanical action between particles in the fluid bed) then they may not last long in service before they require replacement.

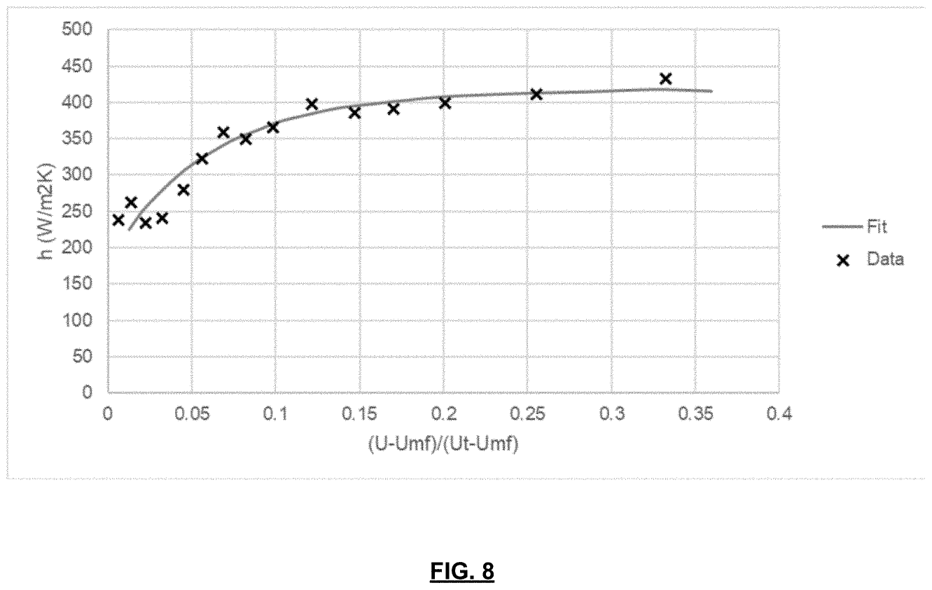

The use of fluidized beds in HYBRX systems is expected to provide significantly improved heat and mass transfer compared to fixed beds of solids in gas/solid contacting applications. For example, FIG. 8 illustrates a typical curve for a bubbling bed of spherical glass particles, 125 micron diameter in atmospheric air, with a turbulent liquid coolant as the heat exchange medium in typical metal tubes with high thermal conductivity.

Based on available experimental data, the trends indicate that higher pressures and smaller particle diameters may lead to higher achievable heat transfer coefficients. It is believed that a value of 700 W/m2 K is a reasonable target for an achievable heat transfer coefficient given small particle size and sufficient gas velocity. The heat transfer coefficient for a HYBRX system will depend on, e.g. the material and size of solid particles that will be used, and/or the refrigerant (or refrigerant mix).

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A thermodynamic power generation system for generating power from a low-grade or mid-grade heat source, the system comprising:
a turbine coupled to an electrical generator;
a closed circuit fluid flow path for a refrigerant, the fluid flow path extending from an outlet of the turbine to an inlet of the turbine, such that the turbine is within the flow path;
an adsorption thermal compressor positioned in the flow path, the adsorption thermal compressor comprising:
an inlet buffer vessel;
an outlet buffer vessel;
two or more fluidized adsorber beds, each adsorber bed containing a sorbent, the two or more fluidized adsorber beds being arranged in parallel, with an inlet end of each adsorber bed in fluid communication with the inlet buffer vessel, and with an outlet end of each adsorber bed in fluid communication with the outlet buffer vessel;
a refrigerant configured to circulate within the fluid flow path, the turbine, and the adsorption thermal compressor, for driving the turbine,
wherein the refrigerant is configured to be adsorbed and desorbed by the sorbent in a vapor phase without condensing into a liquid phase;
wherein the two or more fluidized adsorber beds are in thermal communication with the low-grade or mid-grade heat source,
wherein the two or more fluidized adsorber beds are configured to transfer heat from the low-grade or mid-grade heat source to the refrigerant; and
wherein the two or more fluidized adsorber beds each cycle between an adsorption phase and a desorption phase.

2. The system of claim 1, wherein the two or more fluidized adsorber beds operate out of phase with one another, such that at least one fluidized adsorber bed is adsorbing refrigerant while at least one other fluidized adsorber bed is desorbing refrigerant.

3. The system of claim 1, wherein refrigerant exiting the outlet of the turbine is configured to flow into one of the fluidized adsorber beds during an adsorption phase, and wherein refrigerant entering the inlet of the turbine is configured to flow from one of the fluidized adsorber beds during a desorption phase.

4. The system of claim 1, wherein the two or more fluidized adsorber beds comprise four fluidized adsorber beds, and wherein the four fluidized adsorber beds alternately cycle between a precooling phase, an adsorption phase, a pre-heating phase, and a desorption phase.

5. The system of claim 1, wherein the closed circuit fluid flow path lacks a condenser.

6. The system of claim 1, wherein the closed circuit fluid flow path lacks an evaporator.

7. The system of claim 1, wherein the closed circuit fluid flow path lacks a refrigerant pump.

8. The system of claim 1, wherein the sorbent comprises a metal organic framework with a chemical affinity for the refrigerant.

9. The system of claim 1, wherein the sorbent comprises at least one metal selected from groups Ia, IIa, IIIa, Iva to VIIIa, and Ib to VIb, wherein the at least one metal has a chemical affinity for the refrigerant.

10. The system of claim 1, wherein the sorbent comprises at least one metal selected from the group consisting of Mg, Ca, Sr, Ba, Sc, Y, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, Hg, Al, Ga, In, Ti, Si, Ge, Sn, Pb, As, Sb, Bi, and the lanthanide family, wherein the at least one metal has a chemical affinity for the refrigerant.

11. The system of claim 1, wherein the sorbent comprises at least one metal selected from the group consisting of Zr, Cr, and Fe, wherein the at least one metal has a chemical affinity for the refrigerant.

12. The system of claim 1, wherein the sorbent comprises a covalent organic framework with a chemical affinity for the refrigerant.

13. The system of claim 1, wherein the sorbent comprises a hierarchical porous carbon with a chemical affinity for the refrigerant.

14. The system of claim 1, wherein the sorbent comprises a zeolite or mesoporous silica framework with a chemical affinity for the refrigerant.

15. The system of claim 1, wherein the sorbent comprises a composite combination of two or more of a metal organic framework, a covalent organic framework, a hierarchical porous carbon, and a zeolite or mesoporous silica framework, and wherein the sorbent is in the form of a mixed matrix with a chemical affinity for the refrigerant.

16. The system of claim 1, wherein the fluidized adsorber beds are configured to provide a high capacity uptake of the refrigerant in pores of the sorbent while the refrigerant remains in vapor phase.

17. The system of claim 1, wherein the adsorption thermal compressor further comprises a periodic adsorption power generation system.

18. The system of claim 1, wherein, when a fluidized adsorber bed is in the desorption phase, an output pressure of the adsorber bed falls to a minimum while a temperature of the adsorber bed rises to a maximum, and wherein, when a fluidized adsorber bed is in the adsorption phase, the output pressure of the adsorber bed increases to a maximum while the temperature of the adsorber bed falls to a minimum.

19. The system of claim 1, wherein the refrigerant comprises a pure hydrofluorocarbon (HFC) or hydrofluoroolefin (HFO).

20. The system of claim 1, wherein the refrigerant comprises a mixture of two or more hydrofluorocarbons (HFCs) or hydrofluoroolefins (HFOs).
